(19) United States
(12) Patent Application Publication
(10) Pub. No.: US 2026/0368229 A1
(43) Pub. Date: Nov. 19, 2026

(54) AUTOMATED TERM MODIFICATION PROPOSALS

(71) Applicant: Oracle International Corporation, Redwood Shores, CA (US)

(72) Inventors: Vikas Agrawal, Hyderabad (IN); Didugu Phani Sai Ganesh, Telangana (IN); Krishnan Ramanathan, Karnataka (IN); Jagdish Chand, Pleasanton, CA (US)

(73) Assignee: Oracle International Corporation, Redwood Shores, CA (US)

(21) Appl. No.: 19/208,236

(22) Filed: May 14, 2025

(51) Int. Cl. G06F 16/334; G06F 16/3329; G06F 16/953; G06Q 30/04

(52) U.S. Cl. CPC G06F 16/3347; G06F 16/3329; G06F 16/953; G06Q 30/04

(57) ABSTRACT

Techniques for generating automated term modifications proposals are disclosed. A natural-language query associated with a term for an entity is received. Information associated with the query is retrieved. A language model is used to generate, based on the retrieved information, identification of a first plurality of data structures associated with the query. One or more of the first plurality of data structures are matched with corresponding one or more of the second plurality of data structures within a database, to identify a first subset of a second plurality of data structures. A second subset of the second plurality of data structures is identified among the first subset, based on a relevance of each data structure among the first subset to the query. A database query targeted to the second subset is executed, to identify historical data and a current term for the entity, and a proposed term for the entity.

### BACKGROUND

An organization may reach an agreement with an entity, and terms associated with the agreement dictate one or more conditions of the agreement. An organization may have to keep track of a large number of such terms agreed with a plurality of entities. Keeping track of such a large number of terms, as well as fine tuning and modifying the terms, if needed, is a non-trivial task.

### BRIEF SUMMARY

In various embodiments, a computer-program product tangibly embodied in a non-transitory machine-readable storage medium, includes instructions configured to cause one or more data processors to perform a set of operations including: receiving, via an interface, a natural-language query associated with a term for an entity; retrieving information associated with the natural-language query from one or more external databases that are different from a database storing term-related information about the entity; generating, using one or more trained language models and based at least in part on the retrieved information, identification of a first plurality of data structures associated with the natural-language query; matching, using a vector similarity function, one or more of the first plurality of data structures with corresponding one or more of a second plurality of data structures within the database; identifying a first subset of the second plurality of data structures within the database, based at least in part on the matching; determining a relevance factor between (i) each data structure within the first subset of the second plurality of data structures and (ii) the natural-language query; identifying, among the first subset of the second plurality of data structures, a second subset of the second plurality of data structures, based at least in part on the relevance factors; generating, using the one or more trained language models, a database query targeted to the second subset of the second plurality of data structures within the database; in response to executing the database query, identifying historical data and a current term associated with the entity; based at least in part on the historical data and the current term associated with the entity, identifying a proposed term for the entity; and outputting the proposed term for the entity.

In an example, retrieving the information and generating the identification of the first plurality of data structures comprises: employing a retrieval-augmented generation (RAG) technique to (i) retrieve the information and (ii) generate the identification of the first plurality of data structures, based at least in part on the retrieved information. In an example, retrieving the information comprises retrieving the information from over the Internet. In an example, generating the identification of the first plurality of data structures comprises: hallucinating and/or confabulating, by the one or more trained language models, while generating the identification of one or more of the first plurality of data structures. In an example, identifying, among the first subset of the second plurality of data structures, the second subset of the second plurality of data structures comprises: identifying two or more data structures within the first subset, such that the two or more data structures are joint using one or more foreign keys, wherein one or more data structures within the first subset are disjoint from the identified two or more data structures; and excluding the one or more disjoint data structures from the second subset.

In an example, identifying the second subset of the second plurality of data structures comprises: determining that a first relevance factor of a first data structure within the first subset is higher than a threshold relevance factor; in response to determining that the first relevance factor is higher than the threshold relevance factor, including the first data structure of the first subset within the second subset; determining that a second relevance factor of a second data structure within the first subset is lower than the threshold relevance factor; and in response to determining that the second relevance factor is lower than the threshold relevance factor, excluding the second data structure of the first subset from the second subset. In an example, the set of operations further includes refining the second subset of the second plurality of data structures, by validating concurrence between a first trained language model and a second trained language model on a relevance of each data structure within the refined second subset with the natural-language query. In an example, the current term is a current payment term in accordance with which the entity has agreed to pay an unpaid balance to an organization; and the proposed term is a proposed modification to the current payment term. In an example, the historical data comprises a payment history of the entity that includes a number of times and/or a number of days the entity was late in repaying an outstanding balance.

In an example, the set of actions comprises: estimating a risk factor associated with a probability of the entity defaulting on the current term; and identifying the proposed term for the entity is further based on a credit rating of the entity and/or the risk factor. In an example, the set of actions comprises: identifying a reason for modifying the current term to the proposed term; and outputting the reason for modifying the current term to the proposed term.

In various embodiments, a computer-implemented method for generating automated term modification proposals comprises: receiving, via an interface, a natural-language query associated with a term for an entity; retrieving information associated with the natural-language query from one or more external databases that are different from a database storing term-related information about the entity; generating, using one or more trained language models and based at least in part on the retrieved information, identification of a first plurality of data structures associated with the natural-language query; matching, using a vector similarity function, one or more of the first plurality of data structures with corresponding one or more of a second plurality of data structures within the database; identifying a first subset of the second plurality of data structures within the database, based at least in part on the matching; determining a relevance factor between (i) each data structure within the first subset of the second plurality of data structures and (ii) the natural-language query; identifying, among the first subset of the second plurality of data structures, a second subset of the second plurality of data structures, based at least in part on the relevance factors; generating, using the one or more trained language models, a database query targeted to the second subset of the second plurality of data structures within the database; in response to executing the database query, identifying historical data and a current term associated with the entity; based at least in part on the historical data and the current term associated with the entity, identifying a proposed term for the entity; and outputting the proposed term for the entity.

In an example, retrieving the information and generating the identification of the first plurality of data structures comprises: employing a retrieval-augmented generation (RAG) technique to (i) retrieve the information and (ii) generate the identification of the first plurality of data structures, based at least in part on the retrieved information. In an example, generating the identification of the first plurality of data structures comprises: hallucinating and/or confabulating, by the one or more trained language models, while generating the identification of one or more of the first plurality of data structures. In an example, identifying, among the first subset of the second plurality of data structures, the second subset of the second plurality of data structures comprises: identifying two or more data structures within the first subset, such that the two or more data structures are joint using one or more foreign keys, wherein one or more data structures within the first subset are disjoint from the identified two or more data structures; and excluding the one or more disjoint data structures from the second subset.

In an example, identifying the second subset of the second plurality of data structures comprises: determining that a first relevance factor of a first data structure within the first subset is higher than a threshold relevance factor; in response to determining that the first relevance factor is higher than the threshold relevance factor, including the first data structure of the first subset within the second subset; determining that a second relevance factor of a second data structure within the first subset is lower than the threshold relevance factor; and in response to determining that the second relevance factor is lower than the threshold relevance factor, excluding the second data structure of the first subset from the second subset. In an example, the current term is a current payment term in accordance with which the entity has agreed to pay an unpaid balance to an organization; and the proposed term is a proposed modification to the current payment term.

In various embodiments, a system comprises: one or more processors; and one or more non-transitory computer-readable media storing instructions, which, when executed by the system, cause the system to perform a set of actions including: receiving, via an interface, a natural-language query associated with a term for an entity; retrieving information associated with the natural-language query from one or more external databases that are different from a database storing term-related information about the entity; generating, using one or more trained language models and based at least in part on the retrieved information, identification of a first plurality of data structures associated with the natural-language query; matching, using a vector similarity function, one or more of the first plurality of data structures with corresponding one or more of a second plurality of data structures within the database; identifying a first subset of the second plurality of data structures within the database, based at least in part on the matching; determining a relevance factor between (i) each data structure within the first subset of the second plurality of data structures and (ii) the natural-language query; identifying, among the first subset of the second plurality of data structures, a second subset of the second plurality of data structures, based at least in part on the relevance factors; generating, using the one or more trained language models, a database query targeted to the second subset of the second plurality of data structures within the database; in response to executing the database query, identifying historical data and a current term associated with the entity; based at least in part on the historical data and the current term associated with the entity, identifying a proposed term for the entity; and outputting the proposed term for the entity. In an example, identifying, among the first subset of the second plurality of data structures, the second subset of the second plurality of data structures comprises: identifying two or more data structures within the first subset, such that the two or more data structures are joint using one or more foreign keys, wherein one or more data structures within the first subset are disjoint from the identified two or more data structures; and excluding the one or more disjoin data structures from the second subset. In an example, the set of actions comprises: identifying a reason for modifying the current term to the proposed term; and outputting the reason for modifying the current term to the proposed term.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following FIGURES, as described below in more detail. However, the following implementations and contexts are but a few of many.

### BRIEF DESCRIPTION OF THE DRAWINGS

Various embodiments are described hereinafter with reference to the FIGURES. It should be noted that the FIGURES are not drawn to scale and that the elements of similar structures or functions are represented by like reference numerals throughout the FIGURES. It should also be noted that the FIGURES are only intended to facilitate the description of the embodiments. They are not intended as an exhaustive description of the disclosure or as a limitation on the scope of the disclosure.

FIG. 1A illustrates a term processing service configured to process and propose adjustments to terms agreed by an organization with a plurality of entities.

FIG. 1B symbolically illustrates a plurality of terms between an organization and a corresponding plurality of entities.

FIG. 2A illustrates a table depicting examples of a plurality of payment terms, and cost of capital for extending each of the payment terms for two difference example values of weighted average cost of capital (WACC).

FIGS. 2B, 2C, 2D, 2E, and 2F illustrate various data structures stored within a storage repository.

FIG. 3A illustrates a data flow diagram depicting a process of identifying one or more data structures that are to be used to address a query associated with a term agreed upon between an organization and an entity.

FIG. 3B illustrates examples of various sets of data structures.

FIG. 4 illustrates a data flow diagram depicting a process of proposing adjustment to a payment term between an organization and an entity, in response to a natural-language query associated with the payment term.

FIGS. 5A, 5B, and 5C illustrate various example use cases of proposed modification in payment terms offered by a term processing service to various entities.

FIGS. 6A and 6B illustrate a flow chart depicting a method for generating automated term modification proposals.

FIG. 7 depicts a simplified diagram of a distributed system for implementing certain aspects.

FIG. 8 is a simplified block diagram of one or more components of a system environment by which services provided by one or more components of an embodiment system may be offered as cloud services, in accordance with certain aspects.

FIG. 9 illustrates an example computer system that may be used to implement certain aspects.

### DETAILED DESCRIPTION

As described above, an organization may reach an agreement with an entity, and a term associated with the agreement dictates one or more conditions of the agreement. It is expected that the entity adheres to the conditions laid out in the term. As an example, an organization may extend credit to an entity, for goods and/or services provided by the organization to the entity. A payment term may be agreed upon between the organization and the entity, where the entity is supposed to return an unpaid balance to the organization in accordance with the payment term. If the entity violates the payment term (such as through late payments or no payments), such violation adversely impacts working capital of the organization and increases opportunity costs and capital expenses for the organization. In another example, the term may dictate another type of contractual agreement between the organization and the entity. An organization may enter into a plurality of terms with a plurality of entities. Keeping track of such a large number of terms, as well as fine tuning and modifying the terms, if needed, is a non-trivial task.

Techniques are described herein for tracking a plurality of terms for an organization, and automated generating of proposals for modifying the terms, if dictated by a plurality of factors associated with the terms. For example, a user of the organization provides a natural language query associated with suggestions to modify a payment term agreed between the organization and an entity. As described herein, the phrase “term” may be used for any of various possible types of terms agreed between two parties (such as the organization and an entity), such as payment terms, contractual terms, etc. Although some examples and embodiments described herein are in the context of payment terms, the teachings of this disclosure may also be used for processing other types of terms as well, such as contractual terms, interest rate terms, and/or the like.

In any case, a term processing service receives the query. The term processing service may be part of a generic query processing service. Thus, the service, upon receiving the query, may not be aware that the query is associated with payment terms. Merely as examples, the query may be for any of an employee expense reimbursement, an human resource (HR) department question that the personnel entering the query has, a payment term related query, a salary related query, an invoice related query, a supply-chain related query, or another type of query.

In an example, the term processing service has access to a storage repository that stores a plurality of data structures storing various payment term related information, such as a current payment term the organization has with the entity, a credit history of the entity, whether the entity repaid any unpaid balances to the organization on time, a number of instances and/or a number of days by which the entity was late in the past in repaying unpaid balances to the organization, etc. In an example, the storage repository may include data for application areas as well, for example, data associated with employee expense reimbursement, HR department documents, salary related information, invoice related information, supply-chain related information, or another type of information.

The term processing service parses the natural-language query. At this point, the term processing service is unaware as to which of the data structures stored within the storage repository is relevant in responding to the query. In an example, the term processing service comprises one or more trained machine learning language models, such as large language models (LLMs).

In an example, the one or more language models parses the query and identifies a plurality of possible data structures that may be relevant to the query. In an example, the one or more language models relies on retrieval-augmented generation (RAG), to generate the plurality of possible data structures. For example, as described below in further detail, the language models (or a data structure retrieval service described below) retrieves relevant information from an external source (such as an external document database, and over the Internet). Subsequently, the one or more language models identify the plurality of possible data structures (e.g., which the language models deem relevant to the query), based at least in part on the retrieved information. At this point, the language models may not yet have parsed a database schema stored within the storage repository and/or a first plurality of data structures stored within the storage repository. Rather, the identified plurality of possible data structures is identified based on evaluating the query and/or the retrieved information. In an example, while identifying the plurality of possible data structures, the language models may hallucinate and/or confabulate. For example, the identified plurality of possible data structures need not exactly match with the first plurality of data structures stored within the storage repository. Thus, the identification of the plurality of possible data structures need not be accurate, and the trained language models are used to identify a broad category of possible data structures that may be relevant to the query, irrespective of whether the identified plurality of possible data structures fully matches with the first plurality of data structures actually stored within the storage repository.

Subsequently, the language models perform a semantic matching between the identified plurality of possible data structures with the first plurality of data structures stored within the storage repository. Cosine similarity or another type of similarity determination technique may be used. A first subset of the first plurality of data structures (which are stored within the storage repository), each of which matches corresponding ones of the plurality of possible data structures, are identified.

Now, each of the first subset of the first plurality of data structures may not be relevant to resolve the query. The term processing service (such as one or more language models) assigns a relevance score to each of the first subset of the first plurality of data structures, based on a relevance of the corresponding data structure with the query, as described below in further detail. Based on the relevance scorers, a second subset of the first subset of the first plurality of data structures is selected. In an example, in addition to (or instead of) relying on the relevance, the term processing service may also rely on a connectiveness of the data structures within the first subset, to select the second subset from the first subset, as described below in further detail. In an example, concurrence between two language models may also be used to select and/or file tune the second subset of data structures, as also described below in further detail. Thus, the second subset of the first plurality of data structures represent data structures that are stored within the storage repository and have been deemed relevant in resolving the query received by the term processing service.

In an example, one or more trained language models then generate one or more database queries targeted to the second subset. The database queries gather data relevant to responding to the query. As an example, if the query is associated with proposal for adjustments to a payment term between the organization and a given entity, the database queries aim to gather various payment term related information associated with the given entity, such as a current payment term the organization has with the entity, a credit history of the entity, whether the entity repaid any unpaid balances to the organization on time, a number of instances and/or a number of days by which the entity was late in the past in repaying unpaid balances to the organization, etc. In an example, the term processing service also analyzes one or more risk factors associated with the entity.

Once the term processing service has access to various payment term related information associated with the entity, the term processing service processes such information and proposes adjustments to the term. The adjustments to the term may be performed by one or more trained machine learning language models and/or using rule-based algorithms. The term processing service outputs the proposed adjustments to the term, which may then be formally agreed upon by the organization and the entity.

One of the technical challenges addressed by some embodiments of the disclosure relates to identifying data structures within a storage repository that may be relevant in responding to a query for adjusting a payment term, and performing such identification at scale. Because the query may be related to a payment term or may relate to any other subject matter (examples of which are described above), it may be challenging for a traditional system to pinpoint specific one or more data structures among a large set of data structures storing varied types of data associated with a variety of topics of the organization. Even with access to computational tools, a human attempting to manually parse and classify queries and identifying relevant data structures within the storage repository would face severe limitations in speed, consistency, and scalability-especially when dealing with diverse linguistic query expressions and high-volume query streams.

A technical solution provided by some embodiments includes techniques that leverage on retrieval of relevant information from outside the storage repository, and using such retrieved information to identify possible data structures that may be used to respond to a query. For example, when identifying the possible data structures that may be used to respond to the query, it may be intended that the trained language models hallucinate and/or confabulate, to come up with a large variety and category of possible data structures. For example, the identified possible data structures need not exactly match with the actual data structures stored within the storage repository. Thus, the retrieval of the information and the identification of the possible data structures need not be accurate, and the trained language models are used to identify a broad category of possible data structures that may be relevant to the query, irrespective of whether the identified possible data structures are actually stored within the storage repository. Subsequently, as described above and also described below in further detail, data structures within the set of the possible data structure having some degree of similarity with the data structures stored in the storage repository are identified, to identify relevant data structures from the storage repository that are relevant to the query. Such retrieval of relevant information from an external dataset (such as over the Internet) and generation of the possible data structures, and subsequent matching of the possible data structures with the actual data structures stored in the storage repository aids in processing linguistically varied query expressions and high-volume query streams related to a large variety of topics, and cannot be replicated by human judgment or conventional rule-based logic alone. This approach provides a technical advantage of dynamically interpreting generic queries and identifying data structures relevant in responding to the queries.

Another technical challenge addressed by some embodiments of the disclosure relates to proposing modifications to payment terms, and performing such proposed modifications at scale. For example, proposing a payment term and/or adjusting the payment term necessitates consideration of a variety of factors, some of which are described below in further details. Even with access to computational tools, a human attempting to manually propose modifications to payment terms, while considering a plurality of factors that can affect the payment term, would face severe limitations in speed, consistency, and scalability. A technical solution provided by some embodiments includes techniques that leverage on data-rich end-to-end decision making, where database queries are generated by machine learning models to gather a variety of complex factors, and payment term adjustment proposals are based on such a variety of complex factors that tend to change with time. Numerous examples and embodiments are now described below.

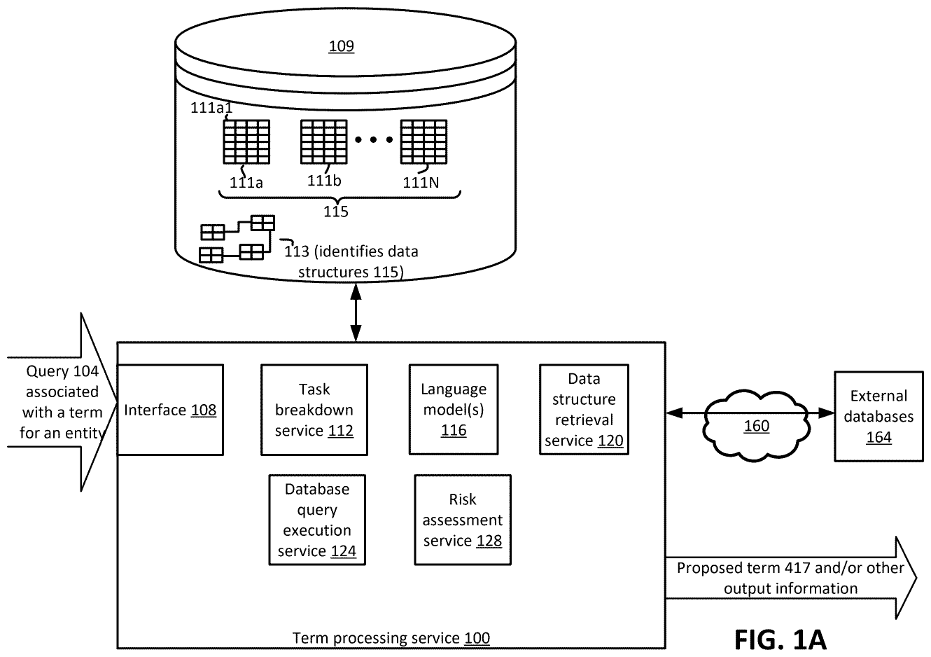

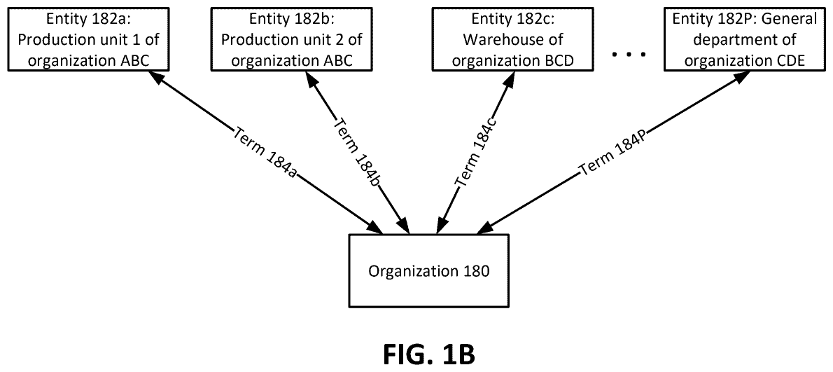

FIG. 1A illustrates a term processing service 100 configured to process and propose adjustments to terms agreed by an organization 180 with a plurality of entities 182a, 182b, . . . , 182P. FIG. 1B symbolically illustrates a plurality of terms 184a, . . . , 184P between an organization 180 and a corresponding plurality of entities 182a, . . . , 182P. In an example, the term processing service 100 of FIG. 1A is operated by personnel of the organization 180 (or another contractor hired directly or indirectly by the organization 180). For example, the term processing service 100 processes and suggests adjustments to terms agreed by the organization 180 with one or more of the entities 182a, . . . , 182P of FIG. 1B.

The organization 180 of FIG. 1B may be any organization that provides goods and/or services to the entities 182a, . . . , 182P. An entity may be any organization or party that receives goods and/or services from the organization 180. FIG. 1B provides examples of some of the entities 182a, 182b, 182c, 182P.

As described above, the phrase “term” may be used for any of various possible types of terms agreed between two parties (such as the organization 180 and an entity 182a), such as payment terms, contractual terms, etc. Although some examples and embodiments described herein are in the context of payment terms, the teachings of this disclosure may also be used for processing other types of terms as well, such as contractual terms, or other types of terms or agreements such as an interest rate term.

In the context of payment terms, the organization 180 may provide goods and/or services to an entity (such as the entity 182a of FIG. 1B), and the entity 182a has to pay the organization 180 for the received goods and/or services. As an example, assume that the organization 180 decides to charge the entity 182a $10,000 for the goods and/or services. A payment agreement between the two parties (e.g., the organization 180 and the entity 182a) is reached, where the payment agreement may include a payment term agreed between the two parties. The payment term may dictate that the entity 182a pays the organization 180 the $10,000 within a certain number of days of receiving the goods and/or services. As an example, a “Net 90” payment term indicates that the entity 182a has agreed to pay the organization 180 the $10,000 within 90 days. In another example, a “5%/10 Net 90” payment term indicates that if the entity 182a pays the organization 180 the $10,000 within 10 days, the entity 182a will receive a 5% discount, and the entity 182a has to pay the entire $10,000 within at most 90 days. As a further example, a “2%/10 Net 120” payment term indicates that if the entity 182a pays the organization 180 the $10,000 within 10 days, the entity 182a will receive a 2% discount, and the entity 182a has to pay the entire $10,000 within at most 120 days. As yet another example, a “Net 0” or “Cash on delivery” payment term indicates that the entity 182a has to pay the organization 180 the $10,000 immediately upon a delivery of the goods and/or services. Each of the payment terms 184a, . . . , 184P agreed between the organization 180 and the corresponding one of the entities 182a, . . . , 182P, thus, may dictate an agreed manner in which the entity is to pay back the organization the money owed for the good and/or services the organization 180 provided to the entity. Thus, a payment term 184a allows the entity 182a an agreed upon number of days (such as 0, 1, 2, or a higher number of days) after the delivery of the goods and/or services, to pay back the organization 180. Accordingly, the organization 180 extends a credit to the entity 182a to pay for the goods and/or services.

In an example, due to the extension of credit to the entity 182a, the organization 180 may have to pay interest on the capital used for late payment. For example, for a Net 180 payment term, the organization 180 may receive the $10,000 as late as 180 days after the delivery of the goods and/or services. This affects the working capital availability of the organization 180, and opportunity cost and/or capital costs for the organization 180. Moreover, if the entity 182a violates the payment term 184a and pays later than the agreed upon terms, this adversely affects the organization 180 even further. For example, if a payment term of Net 180 is agreed upon and the entity 182a pays after 200 days instead, the organization 180 does not have availability of the capital for 20 additional days.

In an example, the cost of capital to the organization 180 may be expressed as a weighted average cost of capital (WACC). WACC is a rate that a company or entity is expected to pay on average to all its security holders to finance its assets, weighted by the proportion of each source of capital (debt and equity). WACC can be expressed as:

WACC=(E/V*rₑ)+((D/V)*r_{d}*(1−T)), Equation 1

where E is the market value of equity, D is the market value of debt, V (which is E+D) is the total market value of the financing of the entity, rₑ is the cost of equity, r_{d} is the cost of debt, and T is the corporate tax rate. Thus, the WACC associated with the organization 180 is indicative of a cost of capital for the organization 180, in extending the credit in accordance with the payment term 184a to the entity 182a.

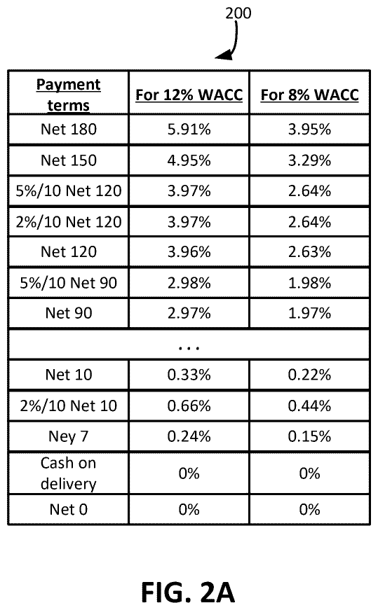

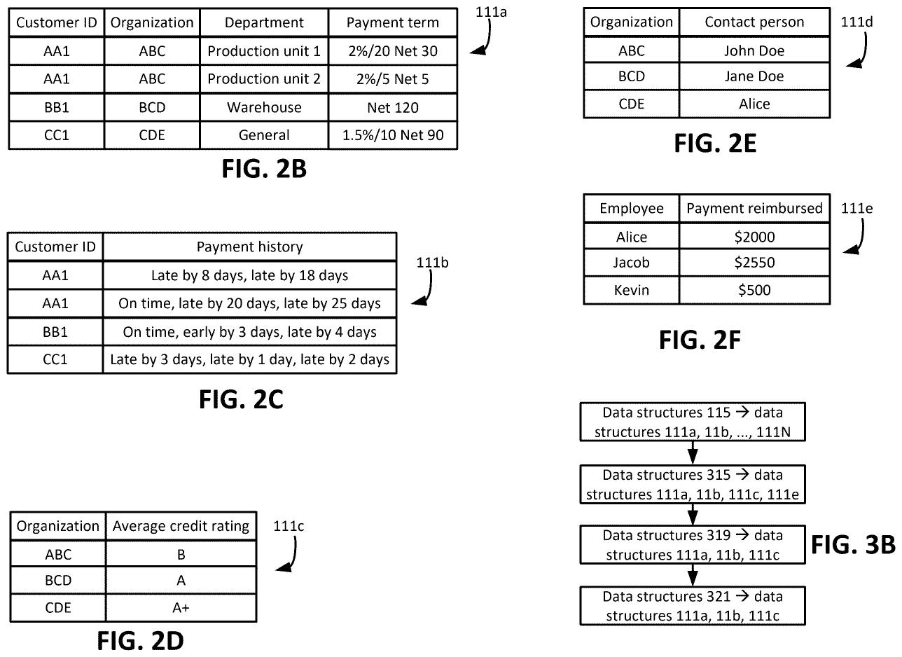

FIG. 2A illustrates a table 200 depicting examples of a plurality of payment terms, and cost of capital for extending each of the payment terms for two different example values of WACC. For example, a first column of the table 200 depicts example payment terms, a second column of table 200 depicts a cost of capital to extend each payment term for a WACC of 12%, and a second column of table 200 depicts a cost of capital to extend each payment term for a WACC of 8%. The WACCs of 12% and 8%, as well as the payment terms depicted in FIG. 2A are mere examples, and do not limit the scope of this disclosure.

For example, for a Net 180 payment term (in which an entity 182 has 180 days to pay the organization 180), the cost of capital is 5.91% if the WACC is assumed to be 12%, and the cost of capital is 3.95% if the WACC is assumed to be 8%. Thus, assuming the WACC of 12%, the organization 180 is expected to incur a loss of 5.91% of $10,000, if the cost of goods and/or services provided is $10,000, and if the entity 182 (such as entity 182a) pays the $10,000 balance 180 days after receiving the goods and/or services. Various other example payment terms depicted in FIG. 2A will be self-evident. As illustrated, the longer the entity 182a is allowed to delay the payment to the organization 180, the higher the cost percentage incurred by the organization 180.

Referring again to FIG. 1A, the term processing service 100 receives a query 104 associated with a term agreed between the organization 180 and an entity 182 (such as the entity 182a). Note that while in some examples of this disclosure the term refers to a payment term, the teachings of disclosure are not limited to payment terms only.

In any case, an interface 108 of the term processing service 100 receives the query 104. The query 104 may be in a natural language format, such as in English or another natural language. The query 104 may be issued by a user of the term processing service 100. The query 104 may be to gather information associated with a payment term agreed by the organization 180 with an entity, a request to find suitable alternatives to a previously agreed upon payment term, evaluate a payment term, etc. Some examples of such a query 104 may be as follows: “Recommend better payment term for the production unit 1 department of ABC organization,” “Evaluate payment terms we have given to the production unit 2 department of ABC organization,” “Given the past payment history of the Warehouse department of company BCD, should we change it's payment term,” “Should we change the payment term of company CDE.” Thus, the query 104 may seek to evaluate or request suggestions to change payment terms agreed upon (or propose a new payment term) with an entity.

The term processing service 100 is communicatively coupled to a storage repository 109 storing a plurality of data structures 111a, 111b, . . . , 111N, at least some of which may be associated with payment terms. The data structures 111a, 111b, . . . , 111N are collectively referred to as data structures 115, as illustrated in FIG. 1A. The data structures 111a, 111b, . . . , 111N may include 1 dimensional columns or rows of data, 2 dimensional tables, or higher dimensional data structures.

FIGS. 2B, 2C, 2D, 2E, and 2F illustrate various data structures 111a, 111b, 111c, 111d, and 111e stored within a storage repository 109. For example, the data structures 111a, 111b, 111c, 111d, and 111e (collectively referred to as data structures 115) are stored within the storage repository 109 that is communicatively coupled to the term processing service 100. As described above, a data structure can be a row or a column of a table within a database, a table within the database, a higher dimensional (such as 3-dimensional or higher) data structure within the database, or so on. In an example, a database schema 113 is also included within the storage repository 109, wherein the database schema 113 includes relationships between the data structures 111a, 111b, 111c, . . . , 111N, primary keys associated with the data structures 111a, 111b, 111c, . . . , 111N, relationship between the data structures 111a, 111b, 111c, . . . , 111N (such as foreign keys), and/or other relevant information and/or metadata associated with the data structures 111a, 111b, 111c, . . . , 111N.

Note that although five example data structures 111a, 111b, 111c, 111d, 111e are illustrated in FIGS. 2B-2F, the storage repository 109 may store other data structures as well, where one or more of such data structures are associated with payment terms.

Referring to FIG. 2B, illustrated is a data structure 111a depicting current payment terms assigned to individual entities (such as individual departments of individual organizations) having unique customer identifications (IDs). For example, a production unit 1 of an ABC organization having customer ID AA1 is currently assigned a 2%/20 Net 30 payment term. Other rows of the data structure 111a will be self-evident.

Referring to FIG. 2C, illustrated is a data structure 111b depicting payment histories for various customer IDs. For example, an entity having the customer ID AA1 has two occurrences of late payments, one by 8 days and the other by 18 days relative to the corresponding agreed upon payment terms.

Referring to FIG. 2D, illustrated is a data structure 111c depicting average credit rating of various organizations. For example, an organization ABC has a credit rating of B, while another organization BCD has a credit rating of A. The credit ratings may be assigned by standard credit rating agencies (such as Standard & Poor's (S & P) Global Ratings™).

Referring to FIG. 2E, illustrated is a data structure 111d depicting contact person for various organizations, such as one or more organizations listed in the data structure 111a. Note that in an example, the data structure 111d may not be relevant in calculating or adjusting payment terms.

Referring to FIG. 2F, illustrated is a data structure 111e depicting payment reimbursed to various employees of an organization. Note that the data structure 111e may not be relevant in calculating payment terms.

Referring again to FIG. 1A, once the term processing service 100 receives the query 104, the query 104 is transmitted to a task breakdown service 112. The task breakdown service 112 analyzes the query 104, and identifies subtasks to be executed, in order to act on the query 104. The task breakdown service 112 may be implemented using one or more trained language models (such as larger language models or LLMs, or small language models or SLMs), or using a combination of one or more language models and rules-based services.

The term processing service 100 further includes one or more language models 116 and a data structure retrieval service 120. The language models 116 and the data structure retrieval service 120 retrieve and identify one or more of the data structures 111a, . . . , 111N that are to be used to address the query 104.

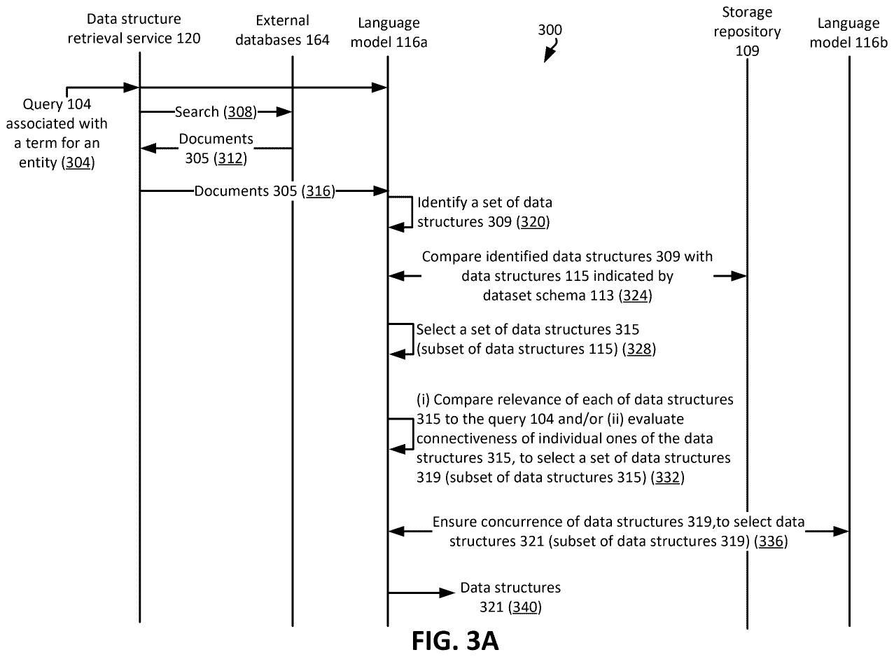

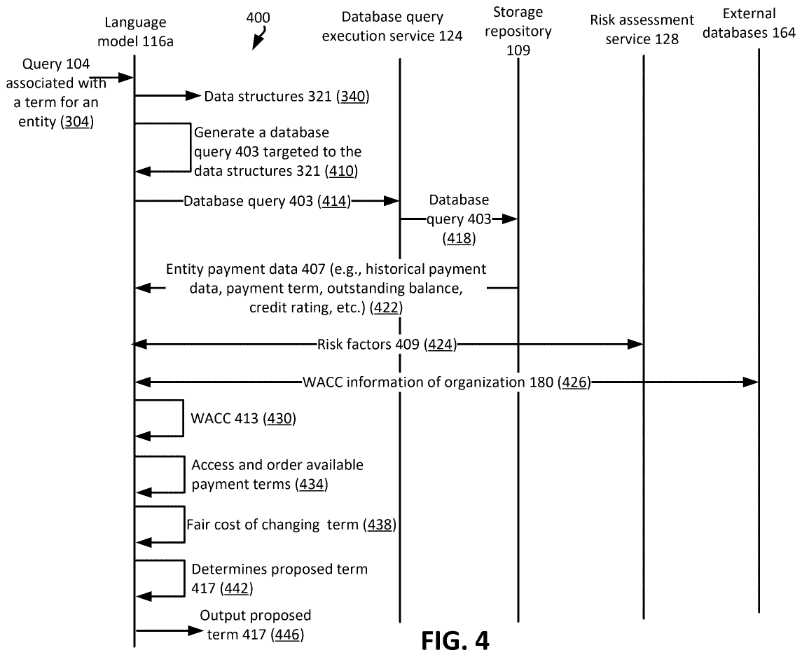

FIG. 3A illustrates a data flow diagram 300 depicting a process of identifying one or more data structures that are to be used to address a query 104 associated with a term (such as a payment term, or another type of term, such as contractual term, described herein) agreed upon between an organization 180 and an entity 182a. FIG. 3B illustrates examples of various sets of data structures referred to in FIG. 3A.

At 304 of FIG. 3A, the data structure retrieval service 120 and a language model 116a receive the query 104 through the interface 108. The language model 116a is one of the one or more language models 116 of the term processing service 100. Individual ones of the language models 116 may be a trained LLM, a trained SLM, or another trained machine learning model.

Upon receiving the query 104, the language model 116a is unaware of one or more of the data structures 115 within the storage repository 109 that may be relevant for the query 104. For example, the language model 116a may be a generic language model shared by the term processing service 100 and one or more other services performing other tasks. Accordingly, at this point, the language model 116a may not be aware that the query relates to payment terms, and/or may not be aware of the data structures within the storage repository 109 to be used to resolve the query 104.

The flow diagram 300 depicts processes by which the language model 116a identifies one or more of the data structures 115 within the storage repository 109 that are to be used to resolve the query 104.

The data structure retrieval service 120 and the language model 116a implements a Retrieval-Augmented Generation (RAG) technique. RAG is a technique in natural language processing (such as with LLMs) that enhances the model's responses, by retrieving relevant information from an external source (such as an external document database or search engine) before generating an answer to a query. For example, the data structure retrieval service 120 receives the query 104, embeds the query 104 to generate an embedded vector corresponding to the query 104, and searches external databases 164 over a public network 160 (such as the Internet, see FIG. 1A) at 308. Thus, the external databases 164 represent data available over a public network, such as the Internet.

At 312, the data structure retrieval service 120 retrieves documents 305 from the external databases 164, such as documents 305 that the data structure retrieval service 120 finds are relevant to the query 104. At 316, the data structure retrieval service 120 transmits the retrieved documents 305 to the language model 116a. Note that although the data structure retrieval service 120 is illustrated to be separate from the language model 116a, in an example, at least some functionalities of the data structure retrieval service 120 may be incorporated within the language model 116a.

At 320, the language model 116a identifies a set of data structures 309 that the language model 116a deems are relevant to the query 104. At this point, the language model 116a may not yet have parsed the database schema 113. For example, the identified data structures 309 are based on evaluating the query 104 and/or the retrieved documents 305, and not necessarily based on the data structures 115 stored within the storage repository 109.

In an example, the set of data structures 309 may include identification of examples tables and/or columns (and/or other types of data structures) that are deemed relevant to the query 104. In another example, the set of data structures 309 may include phrases or keywords for tables and/or columns (and/or other types of data structures) that are deemed relevant to the query 104.

In an example, while identifying the set of data structures 309 at 320, the language model 116a may hallucinate and/or confabulate. For example, the identified data structures 309 need not exactly match with the data structures 115 stored within the storage repository 109. Thus, the identification at 320 need not be accurate, and the trained language model 116a is used to identify a broad category of data structures 309 that may be relevant to the query 104, irrespective of whether the identified data structures 309 are actually stored within the storage repository 109.

At 324, the language model 116a compares the identified data structures 309 with data structures 111a, 111b, . . . , 111N (e.g., which are collectively referred to as data structures 115, see FIG. 1A) stored within the storage repository 109. For example, the language model 116a accesses the dataset schema 113, to identify data structures 115 (such as various tables and columns) stored within the storage repository 109. Subsequently, the language model 116a compares each of the identified data structures 309 with one or more of the data structures 115, to determine if a match exists between one of the data structures 309 and another of the data structures 115. For example, a cosine similarity or another vector similarity function may be employed, to find a match between one or more of the identified data structures 309 with corresponding one or more of the data structures 111a, 111b, . . . , 111N. The one or more of the data structures 115 that matches with corresponding one or more of the data structures 309 is referred to as data structures 315. Thus, at 328, the language model 116a identifies and selects a set of data structures 315, which is a subset of the data structures 115.

For example, the data structures 309 identified by the language model 116a may include identification of tables and columns associated with phrases such as payment term, payment history, credit history, payment, etc. (e.g., as the original query 104 is associated with a term for an entity). Thus, while determining match between the data structures 309 and the data structures 115, the language model 116a may identify data structures 111a, 111b, 111c, 111e (see FIGS. 2B-2F) of the data structures 115 to be matching with one or more of the data structures 309, as each of the data structures 111a, 111b, 111c, 111e include phrases like payment term, payment history, credit history, payment, etc. Note that the data structure 111d of FIG. 2E does not include such phrases, and hence is not matched with the data structures 309. Thus, in this example, the selected data structures 315 include at least in example data structures 111a, 111b, 111c, 111e, as also illustrated in FIG. 3B.

At 332, the language model 116a (i) compares relevance of each of data structures 315 to the query 104 and/or (ii) evaluate connectiveness of individual ones of the data structures 315, to select data structures 319 from the data structures 315 (e.g., such that the data structures 319 is a subset of data structures 315). For example, the data structures 111a, 111b, and 111c may be found relevant to the query 104, while the data structure 111e may not be found relevant to the query 104. Thus, in this example, the set of data structures 319 includes the data structures 111a, 111b, and 111c, as also illustrated in FIG. 3B.

For example, for each data structure within the set of data structures 315 is assigned (e.g., by the language model 116a) a relevance factor, based on a relevance of the data structure to the query 104. If the relevance factor of a data structure within the set of data structures 315 is higher than a threshold relevance factor, the data structure is selected to be included within the set of data structures 319. As an example, the data structure 111a includes payment terms for various departments of various organizations, and hence, may be highly relevant to the query 104 related to payment term. Accordingly, the data structure 111a may be assigned a high relevance factor (e.g., higher than the threshold relevance factor) and may be included within the set of data structures 319. On the other hand, although the data structure 111e includes the phase “payment,” this data structure may not be deemed relevant to the query 104 related to payment term (e.g., as the data structure 111e includes payment reimbursed to employees, and not related to payment terms). Accordingly, the data structure 111e may be assigned a low relevance factor (e.g., lower than the threshold relevance factor) and may not be included within the set of data structures 319. After such assignments of the relevance factors, the set of data structures 319 may include data structures 111a, 111b, 111c, as illustrated in FIG. 3B.

In an example, in addition to (or instead of) comparing the relevance of each of the data structures 315, a connectiveness of individual ones of the data structures 315 is also evaluated, to select the set of data structures 319. For example, the data structures 111a, 111b, 111c of the set of data structures 315 are connected through one or more principal keys and/or foreign keys (e.g., customer ID field is common in data structures 111a, 111b, and organization field is common in data structures 111a, 111c). Accordingly, a smallest graph that connects or joins the data structures within the set of data structures 315 is identified, and the connected data structures are included within the set of data structures 319. For example, the graph connects at least the data structures 111a, 111b, 111c. Disjoints data structures within the set of data structures 315 are excluded from the set of data structures 319.

Thus, in the example of FIGS. 2B-2F and 3B, at 332, the language model 116b selects the set of data structures 319 from the set of data structures 315, where the set of data structures 319 includes the data structures 111a, 111b, 111c.

In an example, at 336, the language model 116a validates the selected set of data structures 319. One or more data structures of the set of data structures 319, which are validated, are selected to form a set of data structures 321 (which is a subset of the set of data structures 319). For example, in addition to the language model 116a, the term processing service 100 may include an addition language model 116b. The language model 116a checks concurrence of each of the data structures 319 with the language model 116b, to validate individual ones of the data structures 319. For example, the language model 116b may check each of the data structures 319, e.g., to determine whether each such data structure is relevant to the query 104. If both the language models 116a, 116b determine that a data structure within the set of data structures 319 is relevant to the query 104, the data structure is included within the set of data structures 321. In the example of FIGS. 2B-2F and 3B, the set of data structures 319 and 321 are the same, such that the set of data structures 321 also include the data structures 111a, 111b, 111c. At 340, the language model 116a outputs identification of the set of data structures 321.

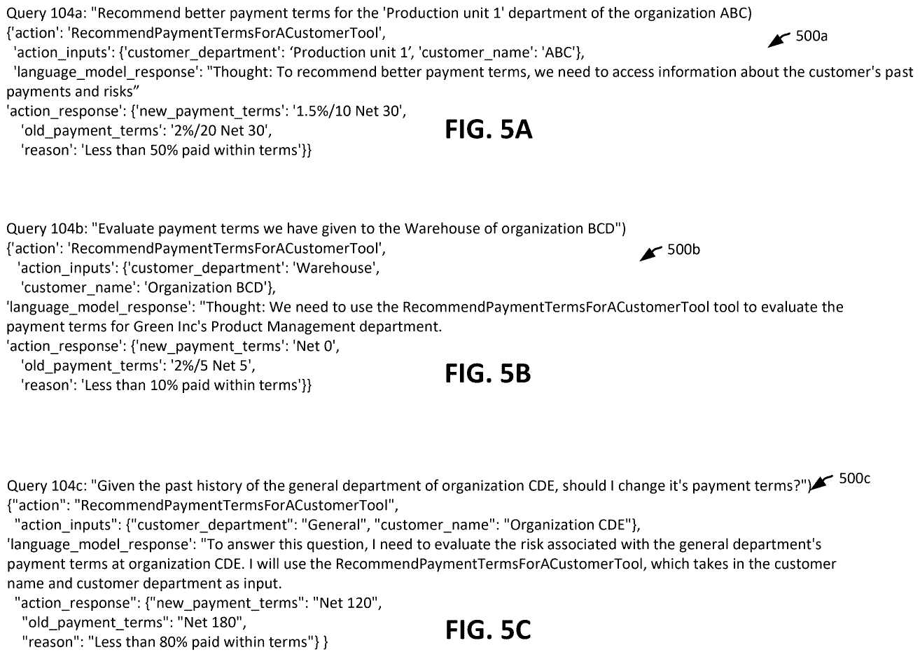

FIG. 4 illustrates a data flow diagram 400 depicting a process of proposing adjustment to a payment term between an organization 180 and an entity 182 (such as the entity 182a of FIG. 1B), in response to a natural-language query 104 associated with the payment term. At 304, a language model 116a receives a query 104. In response, at 340, the language model 116a identifies data structures 321 from the storage repository 109, such that the identified data structures 321 are associated with payment terms, historical payment data, and/or other payment related information associated with the entity 182a. The processes 304 and 340 and one or more intermediate processes (where the intermediate processes are not illustrated in FIG. 4) are described above in further detail with respect to the data flow diagram 300 of FIG. 3A.

At 410, the language model 116a generates a database query 403 targeted to the data structures 321 within the storage repository 109. The database query 403 is to access data associated with the payment term for the entity 182a. In an example, the database query 403 may be in structured query language (SQL) or another language to retrieve data from a relational database management system, such as from the data structures 321, which are a subset of the data structures 115. Note that in an example, instead of the language model 116a, another language model (such as a code generation LLM) may also generate the database query 403.

The database query 403 is based on the natural-language query 104. For example, if the natural-language query 104 is to propose modification to a current term, the database query 403 is to fetch information that is usable to propose modification to the current term.

In an example, the database query 403 may include a series of database queries, represented symbolically as a single database query 403. For example, a first database query may query the data structures 321 for a current payment term for an entity 182a mentioned in the query 104, a second database query may query the data structures 321 for a historical payment data associated with the entity 182a, a third database query may query the data structures 321 for an outstanding balance of the entity 182a (e.g., the balance that the entity owes to the organization 180), a fourth database query may query the data structures 321 for another payment term related information for the entity 182a, and so on.

At 414, the language model 116a transmits the database query 403 to a database query execution service 124 within the term processing service 100 (e.g., through an appropriate application programming interface or API). At 418, the database query execution service 124 queries the data structures 321 (which are a subset of the data structures 115).

At 422, the language model 116a receives (e.g., either through or bypassing the database query execution service 124) responses of the database query 403. For example, the response includes entity payment data 407, such as historical payment data for the entity 182a, current and/or past payment terms for the entity 182a, outstanding balance of the entity 182a, credit rating of the entity 182a, etc.

At 424, the language model 116a communicates with a risk assessment service 128, which accesses one or more risk factors 409 associated with the entity 182a. For example, a first risk factor 409a may provide a probability of the entity 182a going bankrupt within the next one year, a second risk factor 409b may provide a probability of the entity 182a defaulting on the payment (e.g., being late in paying the outstanding balance in accordance with the payment term), and so on. In an example, the risk assessment service 128 may be implemented by the language model 116a or another language model. The risk assessment service 128 may rely on the entity payment data 407 and/or other data associated with the entity 182a (e.g., including data gathered from over the Internet).

At 426, the language model 116a communicates with the external database 164 (e.g., over the public network 160) to gain information about the WACC information of the organization 180. For example, the language model 116a may access financial databases such as Bloomberg®, Capital IQ®, and/or the like, to access information associated with the WACC.

At 430, the language model 116a calculates the WACC 413. In one example, the language model 116a may directly access the WACC 413 from the external databases 164. In another example, the language model 116a may calculate the WACC 413 from information gathered from the external databases 164, e.g., using equation 1 described above.

At 434, the language model 116a accesses available payment terms that the organization 180 offers to different entities, some of which are illustrated in FIG. 2A. In an example, the language model 116a orders or ranks the payment terms by favorability and/or cost for the WACC of the organization. For example, if the WACC of the organization 180 is determined to be 12%, then the payment terms are ordered in accordance with the entries in the second column of the table 200 of FIG. 2A.

Assuming that the query 104 was associated with proposing a change in the payment term for the entity 182a, at 438, the language model 116a calculates a fair cost of changing the term. Merely as an example, refer to FIG. 2A, if the current payment term is 5%/10 120 and the WACC is 12%, then (i) a fair cost to change the payment term to Net 150 would be (4.95-3.97) %, i.e., 0.98%, and (ii) a fair cost to change the payment term to Net 190 would be (5.91-3.97) %, i.e., 1.94%.

Assuming that the query 104 was associated with proposing a change in the payment term for the entity 104, at 442, the language model 116a (or another machine learning model and/or a rule-based service) determines proposed term 417 for the entity 182a. For example, different information about the entity 182a is considered to arrive at the proposed payment term, such as the entity payment data 407 (e.g., historical payment data, current and/or past payment term, outstanding balance, credit rating of the entity 182a, etc.), risk factors 409 associated with the entity 182a, and/or other relevant information associated with the entity 182a. In an example, the proposed payment term 417 may be somewhat fair (such as optimal, or at least sub-optimal) to both the organization 180 and the entity 182a.

At 446, the language model 116a outputs the proposed payment term 417, e.g., which may be displayed on a display screen that is viewable to personnel of the organization 180. Subsequently, the organization 180 may negotiate with the entity 182a, to establish the proposed payment term 417 with the entity 182a. In an example, while outputting the proposed term 417, one or more reasons for selecting the proposed term 417 may be output.

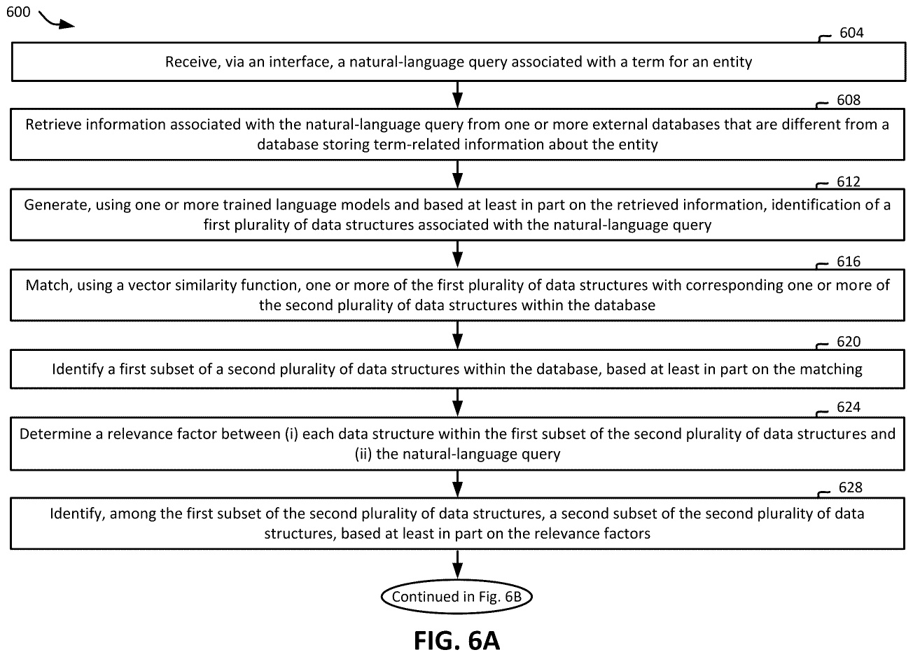

FIGS. 5A, 5B, and 5C illustrate various example use cases 500a, 500b, 500c, respectively, of proposed modification in payment terms offered by the term processing service 100 to various entities. For example, each of the use cases 500a, 500b, 500c includes a corresponding query 104, an old payment term, a proposed new payment term, and a reason for altering the payment term. The use cases 500a, 500b, 500c are represented using JavaScript Object Notation (JSON) format.

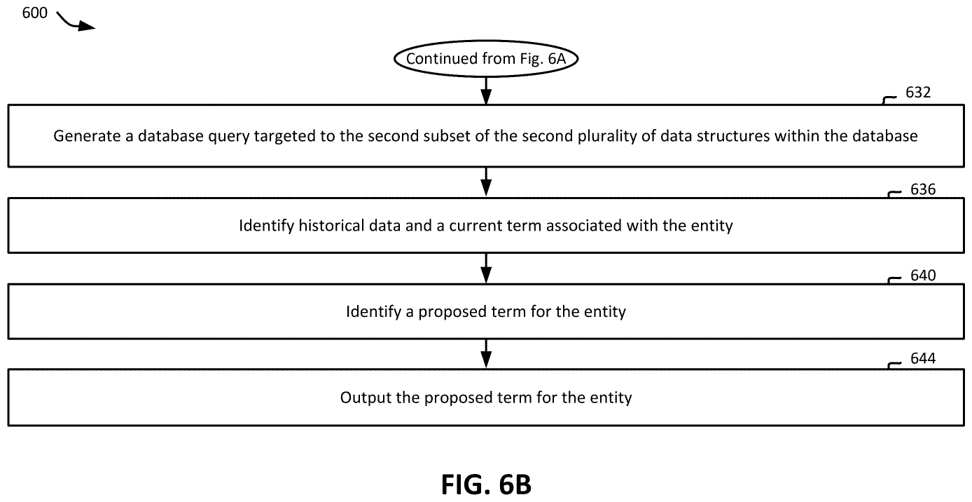

FIGS. 6A and 6B illustrate a flow chart depicting a method 600 for generating automated term modification proposals. The method 600 initiates at FIG. 6A and continues through FIG. 6B.

At 604, a natural-language query (such as query 104) associated with a term for an entity is received via an interface (such as interface 108). The natural-language query may be generated and input by a personnel of the organization 180. Examples of such a query have been described above, as well as illustrated in FIGS. 5A-5C.

At 608, information associated with the natural-language query is retrieved from one or more external databases that are different from a database storing term-related information about the entity, e.g., as described above with respect to 308, 312, and 316 of the data flow diagram 300 of FIG. 3A.

At 612, using one or more trained language models and based at least in part on the retrieved information, identification of a first plurality of data structures associated with the natural-language query are generated, e.g., as described above with respect to 320 of the data flow diagram 300 of FIG. 3A.

At 616, using a vector similarity function, one or more of the first plurality of data structures are matched with corresponding one or more of a second plurality of data structures within the database. At 620, a first subset of the second plurality of data structures within the database are identified, based at least in part on the matching. Processes 616 and 620 are described above with respect to 324 and 328 of the data flow diagram 300 of FIG. 3A.

At 624, a relevance factor between (i) each data structure within the first subset of the second plurality of data structures and (ii) the natural-language query is determined, e.g., as described above with respect to 332 of the data flow diagram 300 of FIG. 3A. At 628, among the first subset of the second plurality of data structures, a second subset of the second plurality of data structures is identified, based at least in part on the relevance factors, e.g., as also described above with respect to 332 of the data flow diagram 300 of FIG. 3A.

From 628 of FIG. 6A, the method 600 proceeds to 632 of FIG. 6B. At 632, a database query is generated, wherein the database query is targeted to the second subset of the second plurality of data structures within the database. In an example, the database query may be generated using the one or more trained language models, e.g., as described above with respect to 410 of the data flow diagram 400 of FIG. 4.

At 636, in response to executing the database query, historical data and a current term associated with the entity are identified, e.g., as described above with respect to 418 and 422 of the data flow diagram 400 of FIG. 4.

At 640, a proposed term for the entity is identified, e.g., based at least in part on the historical data and the current term associated with the entity, e.g., as described above with respect to 442 of the data flow diagram 400 of FIG. 4. At 644, the proposed term for the entity is output, e.g., as described above with respect to 446 of the data flow diagram 400 of FIG. 4.

### Computer System Architecture

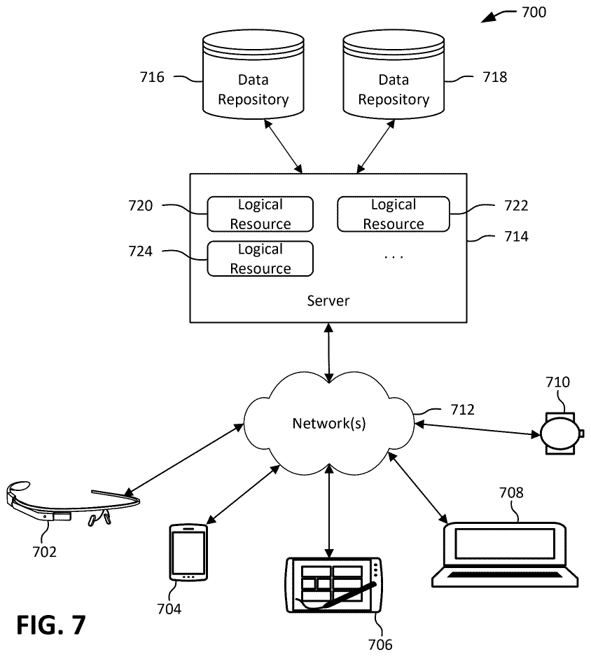

FIG. 7 depicts a simplified diagram of a distributed system 700 for implementing an embodiment. In the illustrated embodiment, distributed system 700 includes one or more client computing devices 702, 704, 706, 708, and/or 710 coupled to a server 714 via one or more communication networks 712. Clients computing devices 702, 704, 706, 708, and/or 710 may be configured to execute one or more applications.

In various aspects, server 714 may be adapted to run one or more services or software applications that enable techniques for generating automated term modification proposals.

In certain aspects, server 714 may also provide other services or software applications that can include non-virtual and virtual environments. In some aspects, these services may be offered as web-based or cloud services, such as under a Software as a Service (Saas) model to the users of client computing devices 702, 704, 706, 708, and/or 710. Users operating client computing devices 702, 704, 706, 708, and/or 710 may in turn utilize one or more client applications to interact with server 714 to utilize the services provided by these components.

In the configuration depicted in FIG. 7, server 714 may include one or more components 720, 722 and 724 that implement the functions performed by server 714. These components may include software components that may be executed by one or more processors, hardware components, or combinations thereof. It should be appreciated that various different system configurations are possible, which may be different from distributed system 700. The embodiment shown in FIG. 7 is thus one example of a distributed system for implementing an embodiment system and is not intended to be limiting.

Users may use client computing devices 702, 704, 706, 708, and/or 710 for techniques for generating automated term modification proposals in accordance with the teachings of this disclosure. A client device may provide an interface that enables a user of the client device to interact with the client device. The client device may also output information to the user via this interface. Although FIG. 7 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 712 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 712 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 714 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 714 can include one or more virtual machines running virtual operating systems, or other computing architectures involving virtualization such as one or more flexible pools of logical storage devices that can be virtualized to maintain virtual storage devices for the server. In various aspects, server 714 may be adapted to run one or more services or software applications that provide the functionality described in the foregoing disclosure.

The computing systems in server 714 may run one or more operating systems including any of those discussed above, as well as any commercially available server operating system. Server 714 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 714 may include one or more applications to analyze and consolidate data feeds and/or event updates received from users of client computing devices 702, 704, 706, 708, and/or 710. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 714 may also include one or more applications to display the data feeds and/or real-time events via one or more display devices of client computing devices 702, 704, 706, 708, and/or 710.

Distributed system 700 may also include one or more data repositories 716, 718. These data repositories may be used to store data and other information in certain aspects. For example, one or more of the data repositories 716, 718 may be used to store information for techniques for generating automated term modification proposals. Data repositories 716, 718 may reside in a variety of locations. For example, a data repository used by server 714 may be local to server 714 or may be remote from server 714 and in communication with server 714 via a network-based or dedicated connection. Data repositories 716, 718 may be of different types. In certain aspects, a data repository used by server 714 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 716, 718 may also be used by applications to store application data. The data repositories used by applications may be of different types such as, for example, a key-value store repository, an object store repository, or a general storage repository supported by a file system.

In one embodiment, server 714 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

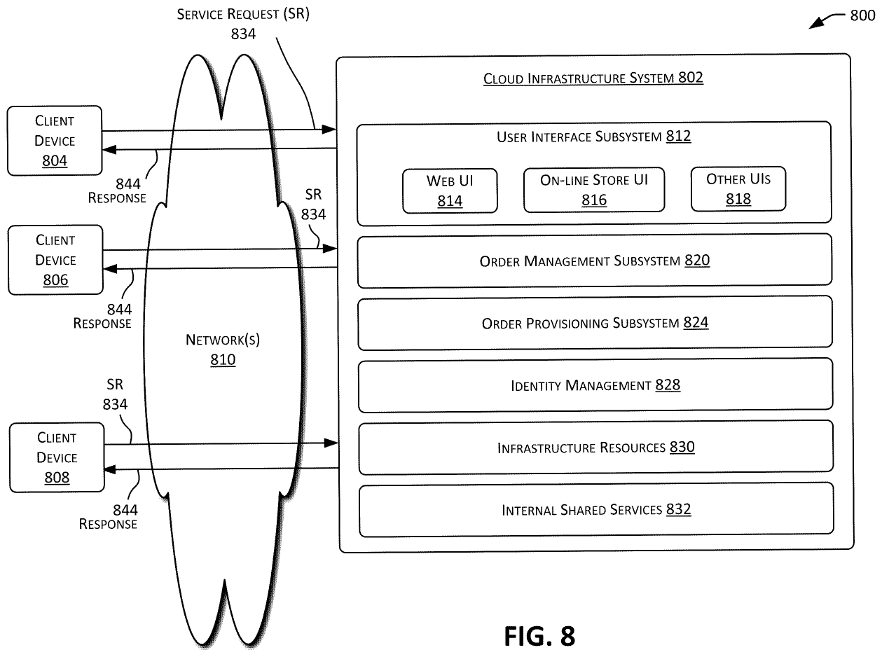

FIG. 8 is a simplified block diagram of a cloud-based system environment in which term modification proposals are generated, in accordance with certain aspects. In the embodiment depicted in FIG. 8, cloud infrastructure system 802 may provide one or more cloud services that may be requested by users using one or more client computing devices 804, 806, and 808. Cloud infrastructure system 802 may comprise one or more computers and/or servers that may include those described above for server 714. The computers in cloud infrastructure system 802 may be organized as general purpose computers, specialized server computers, server farms, server clusters, or any other appropriate arrangement and/or combination.

Network(s) 810 may facilitate communication and exchange of data between clients 804, 806, and 808 and cloud infrastructure system 802. Network(s) 810 may include one or more networks. The networks may be of the same or different types. Network(s) 810 may support one or more communication protocols, including wired and/or wireless protocols, for facilitating the communications.

The embodiment depicted in FIG. 8 is only one example of a cloud infrastructure system and is not intended to be limiting. It should be appreciated that, in some other aspects, cloud infrastructure system 802 may have more or fewer components than those depicted in FIG. 8, may combine two or more components, or may have a different configuration or arrangement of components. For example, although FIG. 8 depicts three client computing devices, any number of client computing devices may be supported in alternative aspects.

The term cloud service is generally used to refer to a service that is made available to users on demand and via a communication network such as the Internet by systems (e.g., cloud infrastructure system 802) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 810 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 802 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 802 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 802. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 802. Cloud infrastructure system 802 then performs processing to provide the services requested in the tenant's subscription order. Cloud infrastructure system 802 may be configured to provide one or even multiple cloud services.

Cloud infrastructure system 802 may provide the cloud services via different deployment models. In a public cloud model, cloud infrastructure system 802 may be owned by a third party cloud services provider and the cloud services are offered to any general public tenant, where the tenant can be an individual or an enterprise. In certain other aspects, under a private cloud model, cloud infrastructure system 802 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 802 and the services provided may be shared by several organizations in a related community. Various other models such as hybrids of the above mentioned models may also be used.

Client computing devices 804, 806, and 808 may be of different types (such as devices 702, 704, 706, and 708 depicted in FIG. 7) and may be capable of operating one or more client applications. A user may use a client device to interact with cloud infrastructure system 802, such as to request a service provided by cloud infrastructure system 802.

In some aspects, the processing performed by cloud infrastructure system 802 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 802 for determining the intent of an utterance. The data used for this analysis may include structured data (e.g., data stored in a database or structured according to a structured model) and/or unstructured data (e.g., data blobs (binary large objects)).

As depicted in the embodiment in FIG. 8, cloud infrastructure system 802 may include infrastructure resources 830 that are utilized for facilitating the provision of various cloud services offered by cloud infrastructure system 802. Infrastructure resources 830 may include, for example, processing resources, storage or memory resources, networking resources, and the like.

In certain aspects, to facilitate efficient provisioning of these resources for supporting the various cloud services provided by cloud infrastructure system 802 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 802 may itself internally use services 832 that are shared by different components of cloud infrastructure system 802 and which facilitate the provisioning of services by cloud infrastructure system 802. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 802 may comprise multiple subsystems. These subsystems may be implemented in software, or hardware, or combinations thereof. As depicted in FIG. 8, the subsystems may include a user interface subsystem 812 that enables users of cloud infrastructure system 802 to interact with cloud infrastructure system 802. User interface subsystem 812 may include various different interfaces such as a web interface 814, an online store interface 816 where cloud services provided by cloud infrastructure system 802 are advertised and are purchasable by a consumer, and other interfaces 818. For example, a tenant may, using a client device, request (service request 834) one or more services provided by cloud infrastructure system 802 using one or more of interfaces 814, 816, and 818. For example, a tenant may access the online store, browse cloud services offered by cloud infrastructure system 802, and place a subscription order for one or more services offered by cloud infrastructure system 802 that the tenant wishes to subscribe to. The service request may include information identifying the tenant and one or more services that the tenant desires to subscribe to. For example, a tenant may place a subscription order for a chatbot related service offered by cloud infrastructure system 802. As part of the order, the client may provide information identifying the input (e.g. utterances).

In certain aspects, such as the embodiment depicted in FIG. 8, cloud infrastructure system 802 may comprise a service management subsystem (OMS) 820 that is configured to process the new order. As part of this processing, OMS 820 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 820 may then invoke the service provisioning subsystem (OPS) 824 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 824 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 802 may send a response or notification 844 to the requesting tenant to indicate when the requested service is now ready for use. In some instances, information (e.g., a link) may be sent to the tenant that enables the tenant to start using and availing the benefits of the requested services.

Cloud infrastructure system 802 may provide services to multiple tenants. For each tenant, cloud infrastructure system 802 is responsible for managing information related to one or more subscription orders received from the tenant, maintaining tenant data related to the orders, and providing the requested services to the tenant or clients of the tenant. Cloud infrastructure system 802 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 802 may provide services to multiple tenants in parallel. Cloud infrastructure system 802 may store information for these tenants, including possibly proprietary information. In certain aspects, cloud infrastructure system 802 comprises an identity management subsystem (IMS) 828 that is configured to manage tenant's information and provide the separation of the managed information such that information related to one tenant is not accessible by another tenant. IMS 828 may be configured to provide various security-related services such as identity services, such as information access management, authentication and authorization services, services for managing tenant identities and roles and related capabilities, and the like.

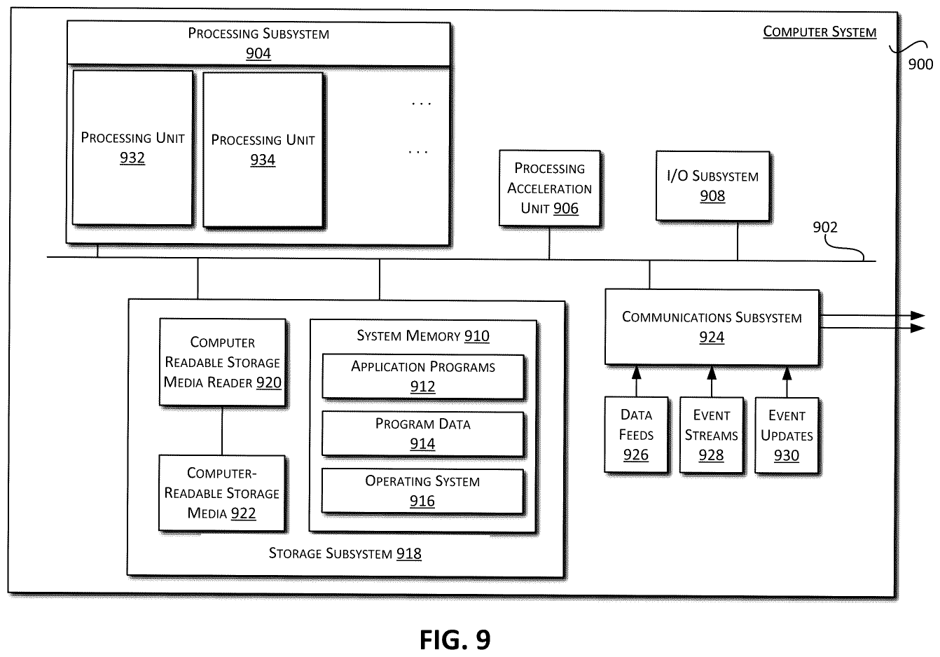

FIG. 9 illustrates an exemplary computer system 900 that may be used to implement certain aspects. As shown in FIG. 9, computer system 900 includes various subsystems including a processing subsystem 904 that communicates with a number of other subsystems via a bus subsystem 902. These other subsystems may include a processing acceleration unit 906, an I/O subsystem 908, a storage subsystem 918, and a communications subsystem 924. Storage subsystem 918 may include non-transitory and/or transitory computer-readable storage media including storage media 922 and a system memory 910.

Bus subsystem 902 provides a mechanism for letting the various components and subsystems of computer system 900 communicate with each other as intended. Although bus subsystem 902 is shown schematically as a single bus, alternative aspects of the bus subsystem may utilize multiple buses. Bus subsystem 902 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 904 controls the operation of computer system 900 and may comprise one or more processors, application specific integrated circuits (ASICs), or field programmable gate arrays (FPGAs). The processors may be single core or multicore processors. The processing resources of computer system 900 can be organized into one or more processing units 932, 934, etc. A processing unit may include one or more processors, one or more cores from the same or different processors, a combination of cores and processors, or other combinations of cores and processors. In some aspects, processing subsystem 904 can include one or more special purpose co-processors such as graphics processors, digital signal processors (DSPs), or the like. In some aspects, some or all of the processing units of processing subsystem 904 can be implemented using customized circuits, such as application specific integrated circuits (ASICs), or field programmable gate arrays (FPGAs).

In some aspects, the processing units in processing subsystem 904 can execute instructions stored in system memory 910 or on computer readable storage media 922. In various aspects, the processing units can execute a variety of programs or code instructions and can maintain multiple concurrently executing programs or processes. At any given time, some or all of the program code to be executed can be resident in system memory 910 and/or on computer-readable storage media 922 including potentially on one or more storage devices. Through suitable programming, processing subsystem 904 can provide various functionalities described above. In instances where computer system 900 is executing one or more virtual machines, one or more processing units may be allocated to each virtual machine.

In certain aspects, a processing acceleration unit 906 may optionally be provided for performing customized processing or for off-loading some of the processing performed by processing subsystem 904 so as to accelerate the overall processing performed by computer system 900.

I/O subsystem 908 may include devices and mechanisms for inputting information to computer system 900 and/or for outputting information from or via computer system 900. In general, use of the term input device is intended to include all possible types of devices and mechanisms for inputting information to computer system 900. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 900 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 918 provides a repository or data store for storing information and data that is used by computer system 900. Storage subsystem 918 provides a tangible non-transitory computer-readable storage medium for storing the basic programming and data constructs that provide the functionality of some aspects. Storage subsystem 918 may store software (e.g., programs, code modules, instructions) that when executed by processing subsystem 904 provides the functionality described above. The software may be executed by one or more processing units of processing subsystem 904. Storage subsystem 918 may also provide a repository for storing data used in accordance with the teachings of this disclosure.

Storage subsystem 918 may include one or more non-transitory memory devices, including volatile and non-volatile memory devices. As shown in FIG. 9, storage subsystem 918 includes a system memory 910 and a computer-readable storage media 922. System memory 910 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 900, such as during start-up, may typically be stored in the ROM. The RAM typically contains data and/or program modules that are presently being operated and executed by processing subsystem 904. In some implementations, system memory 910 may include multiple different types of memory, such as static random access memory (SRAM), dynamic random access memory (DRAM), and the like.

By way of example, and not limitation, as depicted in FIG. 9, system memory 910 may load application programs 912 that are being executed, which may include various applications such as Web browsers, mid-tier applications, relational database management systems (RDBMS), etc., program data 914, and an operating system 916. By way of example, operating system 916 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 922 may store programming and data constructs that provide the functionality of some aspects. Computer-readable media 922 may provide storage of computer-readable instructions, data structures, program modules, and other data for computer system 900. Software (programs, code modules, instructions) that, when executed by processing subsystem 904 provides the functionality described above, may be stored in storage subsystem 918. By way of example, computer-readable storage media 922 may include non-volatile memory such as a hard disk drive, a magnetic disk drive, an optical disk drive such as a CD ROM, digital video disc (DVD), a Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 918 may also include a computer-readable storage media reader 920 that can further be connected to computer-readable storage media 922. Reader 920 may receive and be configured to read data from a memory device such as a disk, a flash drive, etc.

In certain aspects, computer system 900 may support virtualization technologies, including but not limited to virtualization of processing and memory resources. For example, computer system 900 may provide support for executing one or more virtual machines. In certain aspects, computer system 900 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 900. Accordingly, multiple operating systems may potentially be run concurrently by computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to establish a communication channel to one or more client devices via the Internet for receiving and sending information from and to the client devices. For example, the communications subsystem may be used to transmit a response to a user regarding the inquiry for a chatbot.

Communications subsystem 924 may support both wired and/or wireless communication protocols. For example, in certain aspects, communications subsystem 924 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 924 can provide wired network connectivity (e.g., Ethernet) in addition to or instead of a wireless interface.

Communications subsystem 924 can receive and transmit data in various forms. For example, in some aspects, in addition to other forms, communications subsystem 924 may receive input communications in the form of structured and/or unstructured data feeds 926, event streams 928, event updates 930, and the like. For example, communications subsystem 924 may be configured to receive (or send) data feeds 926 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 924 may be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 924 may also be configured to communicate data from computer system 900 to other computer systems or networks. The data may be communicated in various different forms such as structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 900 depicted in FIG. 9 is intended only as a specific example. Many other configurations having more or fewer components than the system depicted in FIG. 9 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-program product tangibly embodied in a non-transitory machine-readable storage medium, including instructions configured to cause one or more data processors to perform a set of operations including:
receiving, via an interface, a natural-language query associated with a term for an entity;
retrieving information associated with the natural-language query from one or more external databases that are different from a database storing term-related information about the entity;
generating, using one or more trained language models and based at least in part on the retrieved information, identification of a first plurality of data structures associated with the natural-language query;
matching, using a vector similarity function, one or more of the first plurality of data structures with corresponding one or more of a second plurality of data structures within the database;
identifying a first subset of the second plurality of data structures within the database, based at least in part on the matching;
determining a relevance factor between (i) each data structure within the first subset of the second plurality of data structures and (ii) the natural-language query;
identifying, among the first subset of the second plurality of data structures, a second subset of the second plurality of data structures, based at least in part on the relevance factors;
generating, using the one or more trained language models, a database query targeted to the second subset of the second plurality of data structures within the database;
in response to executing the database query, identifying historical data and a current term associated with the entity;
based at least in part on the historical data and the current term associated with the entity, identifying a proposed term for the entity; and
outputting the proposed term for the entity.

2. The computer-program product of claim 1, wherein retrieving the information and generating the identification of the first plurality of data structures comprises:
employing a retrieval-augmented generation (RAG) technique to (i) retrieve the information and (ii) generate the identification of the first plurality of data structures, based at least in part on the retrieved information.

3. The computer-program product of claim 1, wherein retrieving the information comprises retrieving the information from over the Internet.

4. The computer-program product of claim 1, wherein generating the identification of the first plurality of data structures comprises:
hallucinating and/or confabulating, by the one or more trained language models, while generating the identification of one or more of the first plurality of data structures.

5. The computer-program product of claim 1, wherein identifying, among the first subset of the second plurality of data structures, the second subset of the second plurality of data structures comprises:
identifying two or more data structures within the first subset, such that the two or more data structures are joint using one or more foreign keys, wherein one or more data structures within the first subset are disjoint from the identified two or more data structures; and
excluding the one or more disjoint data structures from the second subset.

6. The computer-program product of claim 1, wherein identifying the second subset of the second plurality of data structures comprises:
determining that a first relevance factor of a first data structure within the first subset is higher than a threshold relevance factor;
in response to determining that the first relevance factor is higher than the threshold relevance factor, including the first data structure of the first subset within the second subset;
determining that a second relevance factor of a second data structure within the first subset is lower than the threshold relevance factor; and
in response to determining that the second relevance factor is lower than the threshold relevance factor, excluding the second data structure of the first subset from the second subset.

7. The computer-program product of claim 1, wherein the set of operations further include:
refining the second subset of the second plurality of data structures, by validating concurrence between a first trained language model and a second trained language model on a relevance of each data structure within the refined second subset with the natural-language query.

8. The computer-program product of claim 1, wherein:
the current term is a current payment term in accordance with which the entity has agreed to pay an unpaid balance to an organization; and
the proposed term is a proposed modification to the current payment term.

9. The computer-program product of claim 1, wherein the historical data comprises a payment history of the entity that includes a number of times and/or a number of days the entity was late in repaying an outstanding balance.

10. The computer-program product of claim 1, wherein the set of actions comprises:
estimating a risk factor associated with a probability of the entity defaulting on the current term; and
identifying the proposed term for the entity is further based on a credit rating of the entity and/or the risk factor.

11. The computer-program product of claim 1, wherein the set of actions comprises:
identifying a reason for modifying the current term to the proposed term; and
outputting the reason for modifying the current term to the proposed term.

12. A computer-implemented method for generating automated term modification proposals, the method comprising:
receiving, via an interface, a natural-language query associated with a term for an entity;
retrieving information associated with the natural-language query from one or more external databases that are different from a database storing term-related information about the entity;
generating, using one or more trained language models and based at least in part on the retrieved information, identification of a first plurality of data structures associated with the natural-language query;
matching, using a vector similarity function, one or more of the first plurality of data structures with corresponding one or more of a second plurality of data structures within the database;
identifying a first subset of the second plurality of data structures within the database, based at least in part on the matching;
determining a relevance factor between (i) each data structure within the first subset of the second plurality of data structures and (ii) the natural-language query;
identifying, among the first subset of the second plurality of data structures, a second subset of the second plurality of data structures, based at least in part on the relevance factors;
generating, using the one or more trained language models, a database query targeted to the second subset of the second plurality of data structures within the database;
in response to executing the database query, identifying historical data and a current term associated with the entity;
based at least in part on the historical data and the current term associated with the entity, identifying a proposed term for the entity; and
outputting the proposed term for the entity.

13. The method of claim 12, wherein retrieving the information and generating the identification of the first plurality of data structures comprises:
employing a retrieval-augmented generation (RAG) technique to (i) retrieve the information and (ii) generate the identification of the first plurality of data structures, based at least in part on the retrieved information.

14. The method of claim 12, wherein generating the identification of the first plurality of data structures comprises:
hallucinating and/or confabulating, by the one or more trained language models, while generating the identification of one or more of the first plurality of data structures.

15. The method of claim 12, wherein identifying, among the first subset of the second plurality of data structures, the second subset of the second plurality of data structures comprises:
identifying two or more data structures within the first subset, such that the two or more data structures are joint using one or more foreign keys, wherein one or more data structures within the first subset are disjoint from the identified two or more data structures; and
excluding the one or more disjoint data structures from the second subset.

16. The method of claim 12, wherein identifying the second subset of the second plurality of data structures comprises:
determining that a first relevance factor of a first data structure within the first subset is higher than a threshold relevance factor;
in response to determining that the first relevance factor is higher than the threshold relevance factor, including the first data structure of the first subset within the second subset;
determining that a second relevance factor of a second data structure within the first subset is lower than the threshold relevance factor; and
in response to determining that the second relevance factor is lower than the threshold relevance factor, excluding the second data structure of the first subset from the second subset.

17. The method of claim 12, wherein:
the current term is a current payment term in accordance with which the entity has agreed to pay an unpaid balance to an organization; and
the proposed term is a proposed modification to the current payment term.

18. A system comprising:
one or more processors; and
one or more non-transitory computer-readable media storing instructions, which, when executed by the system, cause the system to perform a set of actions including:
receiving, via an interface, a natural-language query associated with a term for an entity;
retrieving information associated with the natural-language query from one or more external databases that are different from a database storing term-related information about the entity;
generating, using one or more trained language models and based at least in part on the retrieved information, identification of a first plurality of data structures associated with the natural-language query;
matching, using a vector similarity function, one or more of the first plurality of data structures with corresponding one or more of a second plurality of data structures within the database;
identifying a first subset of the second plurality of data structures within the database, based at least in part on the matching;
determining a relevance factor between (i) each data structure within the first subset of the second plurality of data structures and (ii) the natural-language query;
identifying, among the first subset of the second plurality of data structures, a second subset of the second plurality of data structures, based at least in part on the relevance factors;
generating, using the one or more trained language models, a database query targeted to the second subset of the second plurality of data structures within the database;
in response to executing the database query, identifying historical data and a current term associated with the entity;
based at least in part on the historical data and the current term associated with the entity, identifying a proposed term for the entity; and
outputting the proposed term for the entity.

19. The system of claim 18, wherein identifying, among the first subset of the second plurality of data structures, the second subset of the second plurality of data structures comprises:
identifying two or more data structures within the first subset, such that the two or more data structures are joint using one or more foreign keys, wherein one or more data structures within the first subset are disjoint from the identified two or more data structures; and
excluding the one or more disjoin data structures from the second subset.

20. The system of claim 18, wherein the set of actions comprises:
identifying a reason for modifying the current term to the proposed term; and
outputting the reason for modifying the current term to the proposed term.
